(19) United States
(12) Patent Application Publication
(10) Pub. No.: US 2019/0084513 A1
(43) Pub. Date: Mar. 21, 2019

(54) FOUR-POINT SEATBELT DEVICE FOR A VEHICLE

(71) Applicant: TOYOTA JIDOSHA KABUSHIKI KAISHA, Toyota-shi (JP)

(72) Inventor: Kazuhito YAMAMOTO, Toyota-shi (JP)

(73) Assignee: TOYOTA JIDOSHA KABUSHIKI KAISHA, Toyota-shi (JP)

(21) Appl. No.: 16/042,001

(22) Filed: Jul. 23, 2018

(30) Foreign Application Priority Data
Sep. 15, 2017 (JP) 2017-178056

(51) Int. Cl. B60R 21/015; B60R 22/02; B60R 21/0134; B60R 22/48; B60R 22/46

(52) U.S. Cl. CPC B60R 21/01548; B60R 22/02; B60R 21/0134; B60R 2021/01272; B60R 22/46; B60R 2022/027; B60R 22/48

(57) ABSTRACT

A four-point seatbelt device for a vehicle including: a left and right pair of lap belts; a left and right pair of shoulder belts connected with the respective lap belts; a front latch portion connecting and disconnecting the left lap belt and left shoulder belt with the right lap belt and right shoulder belt; a retractor capable of taking up and pulling out the belt; a pull-out amount detection section capable of detecting a pull-out amount of the belt from the retractor; and a sitting posture detection section configured to determine the sitting posture of the occupant on the basis of the pull-out amount detected by the pull-out amount detection section, in a case in which a sitting posture of the occupant changes after the occupant sits on the vehicle seat and the front latch portion is connected.

### CROSS-REFERENCE TO RELATED APPLICATION

This application claims priority under 35 USC 119 from Japanese Patent Application No. 2017-178056, filed on Sep. 15, 2017, the disclosure of which is incorporated by reference herein.

### BACKGROUND

### Technical Field

The present disclosure relates to a four-point seatbelt device for a vehicle.

### Related Art

A four-point seatbelt device may restrain a vehicle occupant more assuredly than a conventional three-point seatbelt device. A four-point seatbelt device requires appropriate control of respective pull-out amounts of left and right lap belts and left and right shoulder belts.

Japanese Patent Application Laid-Open (JP-A) No. 2010-058679 discloses a four-point seatbelt device for a vehicle that improves fastening positions of lap belts and shoulder belts with respect to an occupant.

However, the four-point seatbelt device for a vehicle recited in JP-A No. 2010-058679 gives no consideration to detecting a sitting posture of the occupant when a pull-out amount of a lap belt or shoulder belt is large due to a change in the sitting posture of the occupant. Thus, appropriate restraint by the seatbelt, an airbag and the like may not be obtained.

### SUMMARY

The present disclosure provides a four-point seatbelt device for a vehicle that may, in order to improve a sitting posture of an occupant, detect the sitting posture of the occupant from pull-out amounts of belts.

A first aspect of the present disclosure is a four-point seatbelt device for a vehicle including: a left and right pair of lap belts corresponding with the waist area of an occupant sitting on a vehicle seat; a left and right pair of shoulder belts connected with the respective lap belts, the left and right pair of shoulder belts corresponding with the chest area of the occupant; a front latch portion connecting and disconnecting the left lap belt and left shoulder belt with the right lap belt and right shoulder belt at a front face of the occupant; a retractor disposed at a take-up side end portion of at least one belt of the lap belts and the shoulder belts, the retractor being capable of taking up and pulling out the belt; a pull-out amount detection section capable of detecting a pull-out amount of the belt from the retractor; and a sitting posture detection section configured to determine the sitting posture of the occupant on the basis of the pull-out amount detected by the pull-out amount detection section, in a case in which a sitting posture of the occupant changes after the occupant sits on the vehicle seat and the front latch portion is connected.

According to the first aspect, after a vehicle occupant has sat on the vehicle seat and connected the latch portion of the belts, the four-point seatbelt device for a vehicle of the present disclosure may detect a sitting posture of the occupant on the basis of the pull-out amounts of the belts changing in accordance with the sitting posture of the occupant.

In a second aspect of the present disclosure, in the first aspect described above: the retractor may be provided at the take-up side end portion of each of the left and right shoulder belts; and the sitting posture detection section may determine the sitting posture of an upper body of the occupant in a left-and-right direction on the basis of a reference value which is a pull-out amount of the shoulder belts when the occupant is sitting properly and a pull-out amount of the shoulder belts detected by the pull-out amount detection section at a time of the determination.

According to the second aspect, the four-point seatbelt device for a vehicle of the present disclosure may detect a sitting posture of the upper body of the occupant in the left-and-right direction on the basis of the pull-out amounts of the shoulder belts changing in accordance with the sitting posture of the occupant.

In a third aspect of the present disclosure, in the first aspect described above: the retractor may be provided at the take-up side end portion of each of the left and right lap belts; and the sitting posture detection section may determine the sitting posture of a waist area of the occupant in a left-and-right direction on the basis of a reference value which is a pull-out amount of the lap belts when the occupant is sitting properly and a pull-out amount of the lap belts detected by the pull-out amount detection section a time of the determination.

According to the third aspect, the four-point seatbelt device for a vehicle of the present disclosure may detect the sitting posture of the waist area of the occupant in the left-and-right direction on the basis of the pull-out amounts of the lap belts changing in accordance with the sitting posture of the occupant.

In a fourth aspect of the present disclosure, in the first aspect described above: the retractor may be a single retractor that takes up and pulls out both the left and right lap belts together; and the sitting posture detection section may determine the sitting posture of a waist area of the occupant in a front-and-rear direction on the basis of a reference value which is a pull-out amount of the lap belts when the occupant is sitting properly and a pull-out amount of the lap belts detected by the pull-out amount detection section a time of the determination.

According to the fourth aspect, the four-point seatbelt device for a vehicle of the present disclosure may detect the sitting posture of the waist area of the occupant in the front-and-rear direction on the basis of the pull-out amounts of the lap belts changing in accordance with the sitting posture of the occupant.

In a fifth aspect of the present disclosure, in the second to fourth aspects described above, the sitting posture detection section may set the reference value to a minimum value of pull-out amounts detected by the pull-out amount detection section, between a time when the occupant sits on the vehicle seat and the front latch portion is connected and the time of the determination.

According to the fifth aspect, the four-point seatbelt device for a vehicle of the present disclosure may detect the sitting posture of the occupant from the pull-out amounts of the belts changing in accordance with the sitting posture of the occupant, on the basis that the pull-out amounts of the belts are minimized when the occupant is in a proper sitting posture.

In a sixth aspect of the present disclosure, in the second to fourth aspects described above, the retractor may include an electric motor that takes up the belt; and in a case in which a pull-out amount detected by the pull-out amount detection section exceeds a permitted value that is greater than the reference value for at least a predetermined duration, the sitting posture detection section may control rotation of the electric motor so as to take up the belt with the retractor.

According to the sixth aspect, the four-point seatbelt device for a vehicle of the present disclosure may improve the sitting position of the occupant by taking up a belt when a state in which a pull-out amount of the belt exceeds the permitted value has continued for at least the predetermined duration.

In a seventh aspect of the present disclosure, in the sixth aspect described above, at the start of take-up of the belt, the sitting posture detection section may control the rotation of the electric motor to moderate tension of the belt and to take up the belt intermittently and, when a pull-out amount detected by the pull-out amount detection section exceeds the permitted value after the start of take-up of the belt, the sitting posture detection section may control the rotation of the electric motor to make the tension of the belt greater than at the start of take-up and take up the belt.

According to the seventh aspect, the four-point seatbelt device for a vehicle of the present disclosure may improve the sitting position of the occupant by, when take-up of a belt starts, moderating tension in the belt and taking up the belt intermittently, and if the pull-out amount of the belt still exceeds the permitted value after the start of take-up of the belt, taking up the belt with greater tension in the belt.

According to the first to fourth aspects, in order to improve a sitting posture of an occupant, the four-point seatbelt device for a vehicle of the present disclosure may detect the sitting posture of the occupant from pull-out amounts of the belts that change in accordance with the sitting posture of the occupant.

According to the fifth aspect, the four-point seatbelt device for a vehicle of the present disclosure may enable detection of a sitting posture of an occupant from pull-out amounts of the belts that change in accordance with the sitting posture of the occupant, in order to improve the sitting posture of the occupant on the basis that the pull-out amounts of the belts are minimized when the occupant is in a proper sitting posture.

According to the sixth aspect, the four-point seatbelt device for a vehicle of the present disclosure may control the pull-out amount of a belt and may improve the sitting posture of an occupant, by taking up the belt with a retractor in a state in which the pull-out amount of the belt exceeds a permitted value is at least a predetermined duration.

According to the seventh aspect, the four-point seatbelt device for a vehicle of the present disclosure may control the pull-out amount of a belt and may improve the sitting posture of an occupant by, when take-up of the belt starts, moderating tension in the belt and taking up the belt intermittently, and if the pull-out amount of the belt exceeds a permitted value after the start of take-up of the belt, taking up the belt with increased tension.

### BRIEF DESCRIPTION OF THE DRAWINGS

Exemplary embodiments will be described in detail based on the following figures, wherein:

FIG. 1 is a block diagram showing a schematic structure of a four-point seatbelt device for a vehicle according to a first exemplary embodiment of the present disclosure;

FIG. 2 is a schematic view showing a vehicle seat including the four-point seatbelt device for a vehicle according to the first exemplary embodiment of the present disclosure;

FIG. 3 is a block diagram showing a circuitry of the four-point seatbelt device for a vehicle according to the first exemplary embodiment of the present disclosure;

FIG. 4 is a flowchart showing processes executed by a vehicle ECU of the four-point seatbelt device for a vehicle according to the first exemplary embodiment of the present disclosure;

FIG. 5 is a descriptive diagram showing changes in posture of a vehicle occupant relative to the vehicle seat;

FIG. 6 is a schematic view showing a vehicle seat including a four-point seatbelt device for a vehicle according to a second exemplary embodiment of the present disclosure;

FIG. 7 is a flowchart showing processes executed by a vehicle ECU of the four-point seatbelt device for a vehicle according to the second exemplary embodiment of the present disclosure;

FIG. 8 is a schematic view showing a vehicle seat including a four-point seatbelt device for a vehicle according to a third exemplary embodiment of the present disclosure;

FIG. 9 is a flowchart showing processes executed by a vehicle ECU of the four-point seatbelt device for a vehicle according to the third exemplary embodiment of the present disclosure;

FIG. 10 is a schematic view showing a vehicle seat including a four-point seatbelt device for a vehicle according to a fourth exemplary embodiment of the present disclosure; and

FIG. 11 is a schematic view showing a vehicle seat including a four-point seatbelt device for a vehicle according to a fifth exemplary embodiment of the present disclosure.

### DETAILED DESCRIPTION

### First Exemplary Embodiment

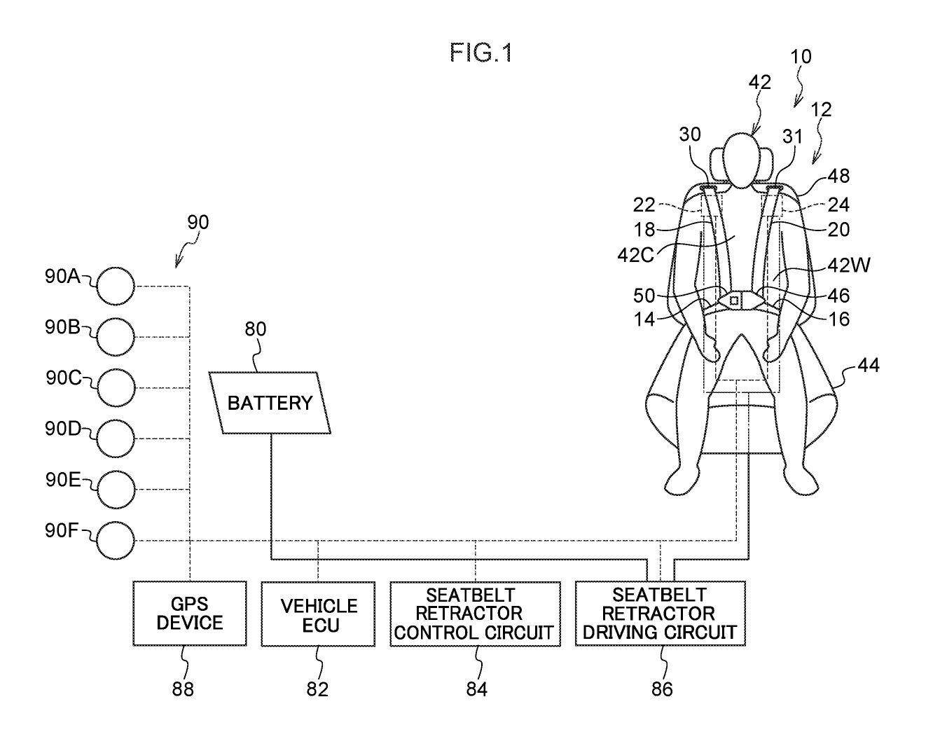

A four-point seatbelt device for a vehicle 10 according to the present exemplary embodiment is described below using FIG. 1 to FIG. 5. In FIG. 1, the solid lines represent power lines along which electric power is conducted, and the broken lines represent signal lines along which control signals are conducted. As shown in FIG. 1, the four-point seatbelt device for a vehicle 10 includes a left and right pair of lap belts 16 and 14 (a left lap belt 16 and a right lap belt 14), a left and right pair of shoulder belts 20 and 18 (a left shoulder belt 20 and a right shoulder belt 18), and retractors 24 and 22.

The left and right pair of lap belts 16 and 14 are non-extensible belt-shaped bodies that correspond with a waist area 42W of an occupant 42 sitting on a vehicle seat 12. The left and right pair of lap belts 16 and 14 are structured to each be capable of being pulled out from, for example, two side portions of a seat cushion 44 of the vehicle seat 12. A buckle device 50, for example, is connected to a distal end of the right lap belt 14 at the vehicle right side. A tongue plate 46, for example, is connected to a distal end of the left lap belt 16 at the vehicle left side. As shown in FIG. 1, when the occupant 42 is fastening the left and right pair of lap belts 14 and 16 and the left and right pair of shoulder belts 18 and 20, the occupant 42 inserts the tongue plate 46 into the buckle device 50 at the front face of the occupant 42 and fixes the tongue plate 46 in the buckle device 50. A buckle switch 90E that detects the fixing of the tongue plate 46 is provided at the buckle device 50. When the tongue plate 46 is properly inserted into the buckle device 50, a buckle-fixed signal is transmitted from the buckle device 50 to, for example, a vehicle ECU 82.

In FIG. 1, the left and right pair of shoulder belts 20 and 18 are respectively connected to the lap belts 14 and 16. The left and right pair of shoulder belts 20 and 18 are non-extensible belt-shaped bodies that correspond with a chest area 42C of the occupant 42. The left and right pair of shoulder belts 20 and 18 are each pull-able out from, for example, an upper portion of a seat back 48 of the vehicle seat 12. To be specific, a distal end of the right shoulder belt 18 at the vehicle right side connects with the buckle device 50, and a distal end of the left shoulder belt 20 at the vehicle left side connects with the tongue plate 46. Penetrating holes (belt guides) 30 and 31 are formed in the upper portion of the seat back 48. The penetrating holes 30 and 31 allow in and out of the shoulder belts 18 and 20 between the interior and exterior of the seat back 48.

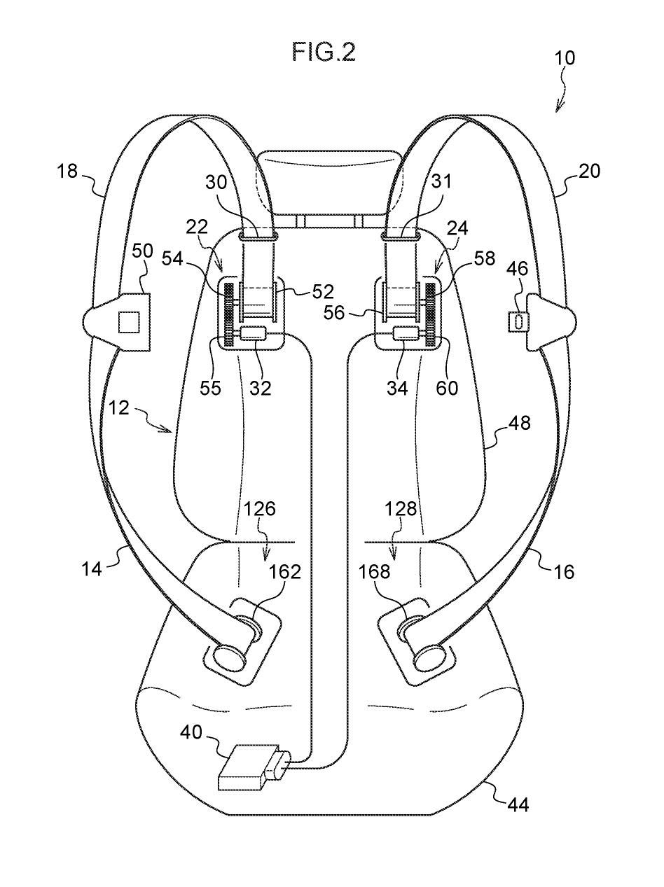

The retractors 22 and 24 are disposed at take-up side end portions of the shoulder belts 18 and 20, respectively. The retractors 22 and 24 takes up the shoulder belts 18 and 20 and drives the shoulder belts 18 and 20 at least in the respective take-up directions with retractor motors 32 and 34 (FIG. 2), which are an example of driving means.

The retractors 22 and 24 are, for example, disposed apart in the vehicle width direction in an upper portion of the interior of the seat back 48 of the vehicle seat 12. The retractor 22 is disposed at the vehicle right side in correspondence with the take-up side end portion of the right shoulder belt 18 at the vehicle right side, and the retractor 24 is disposed at the vehicle left side in correspondence with the take-up side end portion of the left shoulder belt 20 at the vehicle left side.

A battery 80 is a rechargeable battery that is used for starting an engine of the vehicle and as a power source for electrical components in the vehicle. The battery 80 is, for example, a lead-acid battery with a nominal voltage of 12 V.

The vehicle ECU 82 is a control device that controls the engine, electrical components and other equipment of the vehicle. The vehicle ECU 82 is configured by a processor, which is a computational processing unit, a memory device and so forth. In the descriptions of the present exemplary embodiment, a sensor group 90 for detecting vehicle collisions and suchlike is connected to the vehicle ECU 82. When the risk of a vehicle collision is detected by the sensor group 90, the retractor motors 32 and 34 are driven and, by taking up the shoulder belts 18 and 20, remove slackness in the shoulder belts 18 and 20.

In the present exemplary embodiment, recitations of “forward rotation” and “backward rotation” of a motor are used for convenience. In the present exemplary embodiment, descriptions of rotation directions of the motors are simplified to, for example, “forward rotation” for rotation directions of motors for taking up the shoulder belts 18 and 20 and “ backward rotation” for rotation directions of motors for pulling out the shoulder belts 18 and 20.

The sensor group 90 connected to the vehicle ECU 82 includes, for example, a millimeter-wave radar 90A, a laser radar 90B, acceleration sensors 90C, a vehicle-mounted camera 90D, the buckle switch 90E and rotation detection sensors 90F. Sensors of the sensor group 90 that detect the risk of a vehicle collision or a vehicle collision itself include the millimeter-wave radar 90A, the laser radar 90B, the acceleration sensors 90C and the vehicle-mounted camera 90D.

The millimeter-wave radar 90A includes a front millimeter-wave radar that detects distances to obstacles in front of the vehicle, front-side millimeter-wave radars that detect distances to obstacles to the side of the front, a rear millimeter-wave radar that detects distances to obstacles to the rear, and rear-side millimeter-wave radars that detect distances to obstacles to the side of the rear.

The front millimeter-wave radar is provided, for example, close to the middle of a front grille of the vehicle, and the front-side millimeter-wave radars are provided close to the two vehicle width direction ends inside a front bumper. The front millimeter-wave radar and front-side millimeter-wave radars emit millimeter waves to the vehicle front and front-sides, and detect electromagnetic waves reflected from an obstacle. A distance to the obstacle, relative speed compared to the vehicle and suchlike are measured on the basis of propagation times, frequency shifts caused by the Doppler effect, and the like. The rear millimeter-wave radar and rear-side millimeter-wave radars are provided at a rear bumper of the vehicle or the like. The rear millimeter-wave radar and rear-side millimeter-wave radars emit millimeter waves to the vehicle rear and rear-sides, and detect electromagnetic waves reflected from an obstacle. A distance to the obstacle, relative speed compared to the vehicle and suchlike are measured on the basis of propagation times, frequency shifts caused by the Doppler effect, and the like.

The laser radar 90B is a device that illuminates laser light with a shorter wavelength than millimeter waves to the vehicle front and detects obstacles. The laser radar 90B may relatively easily detect non-metallic objects that are hard to detect with a millimeter-wave radar. When the laser light emitted from the laser radar is reflected by an obstacle, the wavelength and phase are changed. The vehicle ECU 82 calculates when an obstacle is present and the distance to the obstacle on the basis of these changes.

The acceleration sensors 90C are sensors that are provided at pre-specified locations of left and right front side members or radiator supports and that detect accelerations produced by impacts against a bumper of the vehicle, which is an object of collision.

The vehicle-mounted camera 90D (a stereo camera) is provided, for example, in a vehicle cabin, close to the middle of an upper part of a front windshield glass. The vehicle-mounted camera 90D images to the front of the vehicle, detects obstacles in the vicinity, and measures distances to the obstacles.

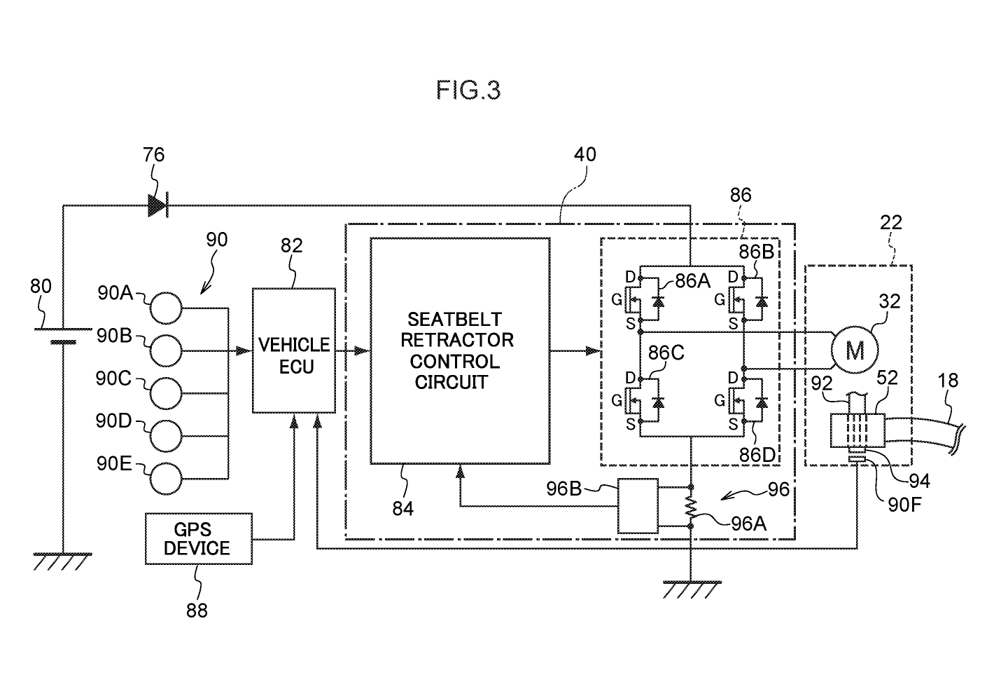

The rotation detection sensors 90F are sensors that detect rotation of respective spools of the retractors 22 and 24. The rotation detection sensors 90F are provided at the respective spools of the retractors 22 and 24 and employ rotary encoders, hole sensors, MR sensors or the like. For example, each rotation detection sensor 90F is a magnetic sensor that detects the magnetic field of a sensor magnet provided at an end portion of a rotary axle of the spool, and more specifically employs an MR sensor or the like. When the rotary axle of the spool rotates, the magnetic field of the sensor magnet changes in association with the rotation. The vehicle ECU 82 calculates a rotation angle and rotation number of the spool from changes in the magnetic field detected by the rotation detection sensor 90F. In a case in which a pull-out amount of the shoulder belt 18 or 20 can be determined be the rotation number of the spool, there is no need to calculate as precisely as calculating the rotation angle of the spool. The rotation detection sensors 90F are basically provided inside the retractors 22 and 24. For convenience in FIG. 1, the rotation detection sensors 90F are depicted in the vicinity of the vehicle ECU 82. An example of disposition of the rotation detection sensors 90F is described using FIG. 3. If the retractor motors 32 and 34 are brushless motors, which are a kind of three-phase synchronous motor, the retractor motors 32 and 34 include hole sensors that detect the rotation of rotors, and these hole sensors may be employed as the rotation detection sensors 90F.

The vehicle ECU 82 acquires detection results from the millimeter-wave radar 90A, laser radar 90B, acceleration sensors 90C and vehicle-mounted camera 90D, and executes collision prediction. Various previously known technologies may be employed for collision prediction, and detailed descriptions are not given here.

A seatbelt retractor driving circuit 86 (below referred to as “the driving circuit 86”) generates voltages to be applied to the retractor motors 32 and 34. As described below, the driving circuit 86 includes an H bridge circuit constituted by switching elements such as field-effect transistors (FETs) or the like. The switching elements constituting the H bridge circuit of the driving circuit 86 are controlled by a seatbelt retractor control circuit 84 (below referred to as “the control circuit 84”).

The control circuit 84 is what is known as a microcomputer and controls the above-mentioned switching elements of the driving circuit 86.

A global positioning system (GPS) device 88 is a device that calculates the current location of the vehicle on the basis of positioning signals received from GPS satellites in the sky. In the present exemplary embodiment, the GPS device 88 that is employed may be dedicated to the four-point seatbelt device for a vehicle 10, or if another GPS device is provided for a car navigation system or the like of the vehicle, this other GPS device may also be employed for the four-point seatbelt device for a vehicle 10.

FIG. 2 is a schematic diagram showing the vehicle seat 12 including the four-point seatbelt device for a vehicle 10. As shown in FIG. 2, a spool 52 and the retractor motor 32 are disposed inside the retractor 22. The spool 52 is capable of taking up the right shoulder belt 18 at the vehicle right side. The retractor motor 32 is capable of driving the spool 52 at least in the take-up direction of the right shoulder belt 18. A gear 54 is attached to a rotary axle of the spool 52, and a gear 55 is attached to a rotary axle of the retractor motor 32. The gears 54 and 55 mesh with one another directly or indirectly. Thus, driving force of the retractor motor 32 is transmitted to the spool 52. In the present exemplary embodiment, the retractor motor 32 is structured to be capable of driving the spool 52 both in the take-up direction of the right shoulder belt 18 and in the pull-out direction of the right shoulder belt 18.

A spool 56 and the retractor motor 34 are disposed inside the retractor 22. The spool 56 is capable of taking up the left shoulder belt 20 at the vehicle left side. The retractor motor 34 is capable of driving the spool 56 at least in the take-up direction of the left shoulder belt 20. A gear 58 is attached to a rotary axle of the spool 56, and a gear 60 is attached to a rotary axle of the retractor motor 34. The gears 58 and 60 mesh with one another directly or indirectly. Thus, driving force of the retractor motor 34 is transmitted to the spool 56. In the present exemplary embodiment, the retractor motor 34 is structured to be capable of driving the spool 56 both in the take-up direction of the left shoulder belt 20 and in the pull-out direction of the left shoulder belt 20.

A retractor ECU 40 is connected to the retractor motors 32 and 34. The control circuit 84 and driving circuit 86 are structured integrally with the retractor ECU 40. The retractor motors 32 and 34 are rotated by voltages applied from the retractor ECU 40, and take up the shoulder belts 18 and 20 onto the spools 52 and 56.

As shown in FIG. 2, retractors 126 and 128 are disposed apart in the vehicle width direction in a lower side rear portion of the seat cushion 44 of the vehicle seat 12. The retractor 126 is disposed at the vehicle right side in correspondence with a take-up side end portion of the right lap belt 14 at the vehicle right side, and the retractor 128 is disposed at the vehicle left side in correspondence with a take-up side end portion of the left lap belt 16 at the vehicle left side. The retractors 126 and 128 do not include retractor motors that take up the lap belts 14 and 16 but do include return springs (not shown in the drawings) that rotate spools 162 and 168 so as to remove slackness in the lap belts 14 and 16 that have been pulled out.

FIG. 3 is a block diagram showing an example of circuitry of the four-point seatbelt device for a vehicle 10 according to the present exemplary embodiment. The control circuit 84 controls the driving circuit 86 in accordance with commands from the vehicle ECU 82. The driving circuit 86 is an H bridge circuit constituted with FETs 86A, 86B, 86C and 86D, which are N-type FETS. The source (S) of the FET 86A is connected to the drain (D) of the FET 86C, and the source of the FET 86B is connected to the drain of the FET 86D. The drains of the FETs 86A and 86B are both connected to the positive terminal of the battery 80 mounted in the vehicle. The sources of the FETs 86C and 86D are both connected to ground via a current detection section 96.

In the present exemplary embodiment, others of the control circuit 84 and driving circuit 86 are dedicatedly provided at the retractor motor 34 and are substantially the same as the circuits associated with the retractor motor 32. Therefore, detailed descriptions of the circuits associated with the retractor motor 34 are not given here.

Each of the N-type FETs constituting the driving circuit 86 functions as a switch that is put into a state in which current flows between the drain and the source (the on state) when a positive charge is applied to the gate (G). In the present exemplary embodiment, when the retractor motor 32 of the retractor 22 is to take up the right shoulder belt 18 onto the spool 52, positive charge control signals are outputted from the control circuit 84 to the gates of the FET 86A and the FET 86D. Thus, the FET 86A and the FET 86D are rotated on and the retractor motor 32 is rotated forward. By positive charge control signals being outputted from the control circuit 84 to the gates of the FET 86B and the FET 86C, the FET 86B and the FET 86C may be rotated on and the retractor motor 32 rotated backward.

When the retractor motor 32 is to be rotated forward, a pulsed voltage is generated from electric power supplied from the battery 80 via a diode 76 and pulse width modulation (PWM) is applied to the retractor motor 32, by either of the FET 86A and the FET 86D of the driving circuit 86 being turned ON and OFF intermittently. Similarly, when the retractor motor 32 is to be rotated backward, a pulsed voltage is generated from electric power supplied from the battery 80 via the diode 76 and pulse width modulation (PWM) is applied to the retractor motor 32, by either of the FET 86B and the FET 86C of the driving circuit 86 being turned ON and OFF intermittently. As described above, because an N-type FET turns ON when a positive charge control signal is applied to the gate, the control circuit 84 implements voltage generation in the driving circuit 86 by the PWM described above by outputting repeating pulse-form control signals that turn ON and OFF intermittently to the gate of either the FET 86A or the FET 86D or to the gate of either the FET 86B or the FET 86C.

An effective voltage value of the voltage applied to the retractor motor 32 is controlled by the voltage applied to the retractor motor 32 being pulsed. If the voltage applied to the retractor motor 32 were not controlled, a current value in a coil of the retractor motor 32 (below referred to as “the motor current”) might exceed a rated current value and the retractor motor 32 might burn out. However, because the voltage applied to the retractor motor 32 is generated by PWM, the effective voltage value may be regulated and burnout of the retractor motor 32 prevented, even when the retractor motor 32 is being rotated at high speeds.

With an amplifier, the current detection section 96 amplifies a potential difference between the two ends of a shunt resistance 96A with a resistance value of the order of 0.2 mΩ to several Ω, and outputs a voltage value proportional to a current in the shunt resistance 96A as signals. The control circuit 84 calculates the motor current on the basis of the signals outputted from the current detection section 96. If there is a risk of the calculated motor current exceeding the rated current value of the retractor motor 32, the control circuit 84 outputs control signals so as to shorten the duration for which the switching element of the driving circuit 86 is intermittently turned ON. With these control signals, the driving circuit 86 reduces the pulse width of the voltage generated by PWM and lowers the effective voltage value. Thus, the motor current may be prevented from exceeding the rated current value.

The retractor motor 32 is a brushed motor driven by direct current. One end of the coil of the retractor motor 32 is connected to the source of the FET 86A structuring the driving circuit 86 and to the drain of the FET 86C. The other end of the coil is connected to the source of the FET 86B structuring the driving circuit 86 and to the drain of the FET 86D. A brushless motor may be used for the retractor motor 32, in which case the above-described driving circuit 86 is formed as a three-phase inverter using six N-type FETs.

As described above, an output shaft of the retractor motor 32 is connected with the spool 52 via the gears 54 and 55. When the retractor motor 32 rotates forward, the right shoulder belt 18 is taken up onto the spool 52. When the retractor motor 32 is rotated backward, the right shoulder belt 18 is pulled out from the spool 52.

The rotation detection sensor 90F is provided to oppose a sensor magnet 94 provided at an end portion of a rotary axle 92 at an end portion of the spool 52. When the spool 52 and rotary axle 92 rotates, the sensor magnet 94 also rotates, and a magnetic field sensed by the rotation detection sensor 90F changes with the rotation. The vehicle ECU 82 calculates the rotation angle and rotation number of the rotary axle 92 from these changes in the magnetic field.

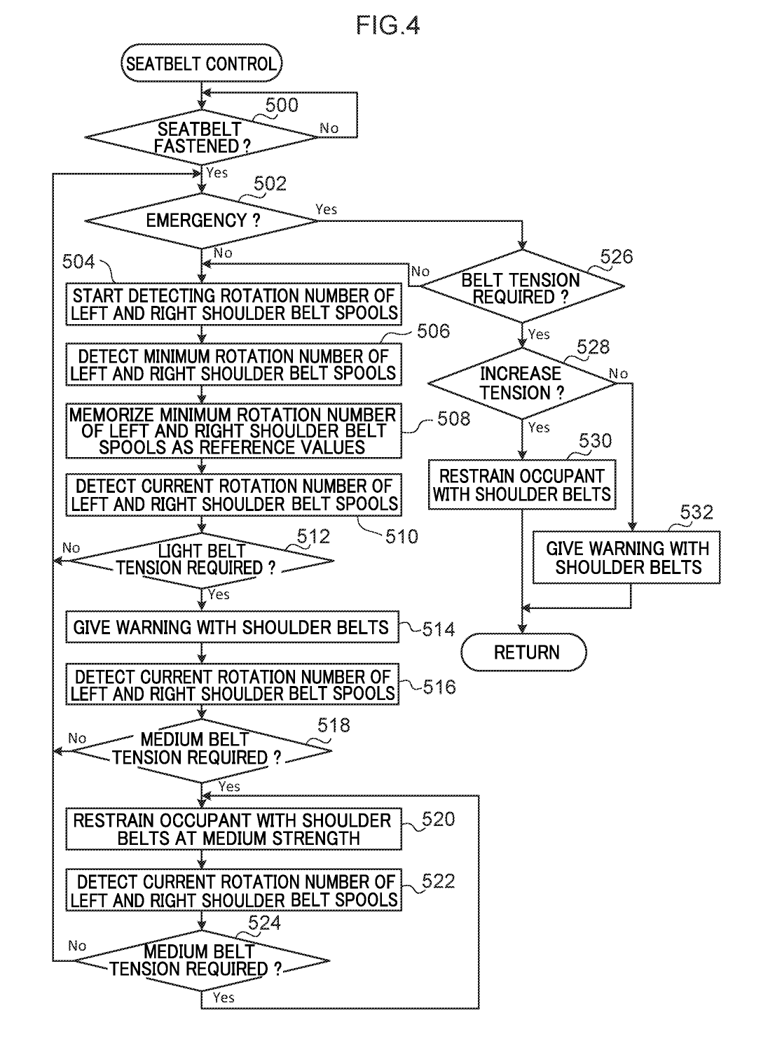

Now, operation of the present exemplary embodiment are described. FIG. 4 is a flowchart showing processes executed by the vehicle ECU 82 of the four-point seatbelt device for a vehicle 10 according to the present exemplary embodiment. In step 500, the vehicle ECU 82 makes a determination from signals from the buckle switch 90E as to whether the seatbelt is fastened. When the seatbelt is fastened, the vehicle ECU 82 advances to step 502.

In step 502, the vehicle ECU 82 makes a determination as to whether there is currently an emergency with a risk of vehicle collision. In the present exemplary embodiment, the result of the determination in step 502 is affirmative when there is a risk of vehicle collision according to the GPS device 88 and detection results from the millimeter-wave radar 90A, the laser radar 90B and the vehicle-mounted camera 90D, for example, when the vehicle ECU 82 is activating an automatic brake of the vehicle and when the vehicle is close to an intersection or the like. When the result of the determination in step 502 is affirmative, the vehicle ECU 82 proceeds to step 526.

When the result of the determination in step 502 is negative, in step 504, detection of rotation number of the respective spools 52 and 56 of the shoulder belts 18 and 20 by the rotation detection sensors 90F or the like is started. Then, in step 506, minimum rotation number of the respective spools 52 and 56 of the shoulder belts 18 and 20 are detected.

In the present exemplary embodiment, pull-out amounts of the shoulder belts 18 and 20 are understood to be smallest when the rotation number of the respective spools 52 and 56 of the shoulder belts 18 and 20 are at minimum. The sitting posture of the occupant 42 is determined to be appropriate when the pull-out amounts of the shoulder belts 18 and 20 are smallest.

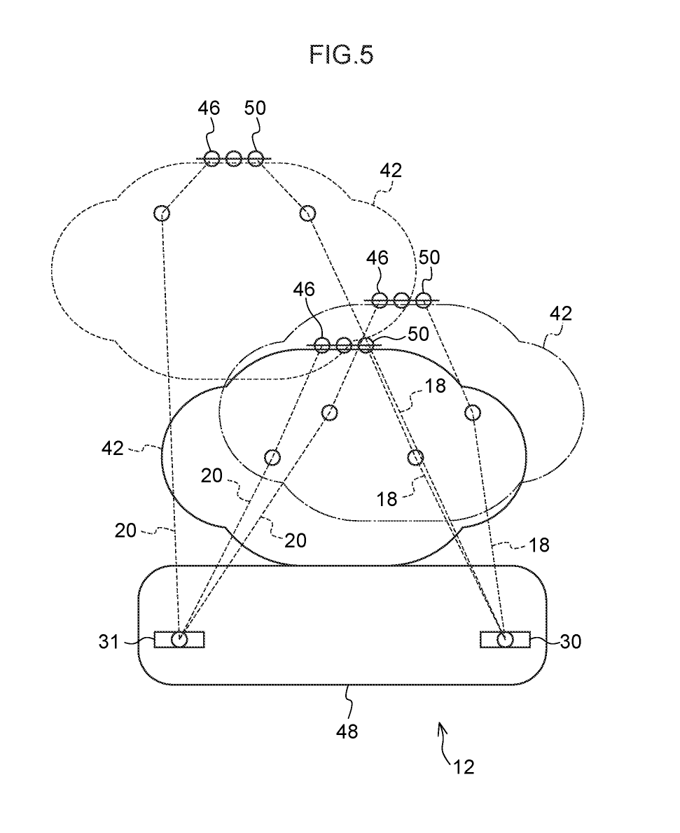

FIG. 5 is a descriptive diagram showing changes in posture of the vehicle occupant 42 relative to the vehicle seat 12. As illustrated in FIG. 5, the pull-out amounts of the shoulder belts 18 and 20 are smallest in a posture in which the upper body of the occupant 42 is in close contact with the seat back 48 of the vehicle seat 12. When the sitting posture of the occupant 42 is disturbed, the pull-out amounts of the shoulder belts 18 and 20 are greater than the minimum rotation number.

In step 508, the minimum rotation number of the respective spools 52 and 56 of the shoulder belts 18 and 20 are memorized as reference values. As mentioned above, in the present exemplary embodiment, the sitting posture of the occupant 42 is determined to be appropriate when the pull-out amounts of the shoulder belts 18 and 20 are smallest. Therefore, using the minimum rotation number of the respective spools 52 and 56 of the shoulder belts 18 and 20 as the reference values, it is determined that the sitting posture of the upper body of the occupant 42 is disturbed in the left-and-right direction when a current rotation number of the spool 52 or 56 is greater than the reference value.

In step 510, the current rotation number of the respective spools 52 and 56 of the shoulder belts 18 and 20 are detected.

In step 512, the vehicle ECU 82 makes a determination as to whether a state in which the rotation number of either of the spools 52 and 56 of the shoulder belts 18 and 20 is at least a permitted value, which is greater than the reference value, has continued for more than a predetermined duration. In step 512, if the state in which the rotation number of the spool 52 or 56 is at least the permitted value has continued for more than the predetermined duration, it is determined that light tension should be applied to each of the shoulder belts 18 and 20 (the result of the determination is affirmative), and the vehicle ECU 82 proceeds to step 514. In the present exemplary embodiment, the result of the determination is affirmative when the state in which the rotation number of the spool 52 or 56 of either of the shoulder belts 18 and 20 is at least the permitted value has continued for more than the predetermined duration. When the rotation number of the respective spools 52 and 56 of the shoulder belts 18 and 20 are not above the permitted values, the result of the determination in step 512 is negative and the vehicle ECU 82 proceeds to step 502. In the present exemplary embodiment, the permitted values and the predetermined duration vary depending on specifications of the four-point seatbelt device for a vehicle 10 and suchlike, and are specifically determined through testing using real equipment and the like.

In step 514, the retractor motors 32 and 34 are rotated, the shoulder belts 18 and 20 are taken up onto the spools 52 and 56, and light tension is applied to the shoulder belts 18 and 20. In the present exemplary embodiment, each spool 52 or 56 for which the state in which the rotation number is at least the permitted value has continued for more than the predetermined duration is rotated to apply tension to the corresponding shoulder belt 18 or 20. The application of tension in step 514 gives a warning to the occupant 42. Therefore, the retractor motors 32 and 34 are rotated intermittently and the shoulder belts 18 and 20 are taken up intermittently. Then, in step 516, the current rotation number of the respective spools 52 and 56 of the shoulder belts 18 and 20 are detected.

In step 518, the vehicle ECU 82 makes a determination as to whether the state in which the rotation number of either of the spools 52 and 56 of the shoulder belts 18 and 20 is at least the permitted value greater than the reference value is still continuing. In step 518, if the state in which the rotation number of the spool 52 or 56 is at least the permitted value is continuing, it is determined that a medium-level tension should be applied to each of the shoulder belts 18 and 20 (the result of the determination is affirmative), and the vehicle ECU 82 proceeds to step 520. In the present exemplary embodiment, the result of the determination is affirmative when the state in which the rotation number of the spool 52 or 56 of either of the shoulder belts 18 and 20 is at least the permitted value is still continuing. When the rotation number of the respective spools 52 and 56 of the shoulder belts 18 and 20 are not above the permitted value, the result of the determination in step 518 is negative and the vehicle ECU 82 proceeds to step 502.

In step 520, the retractor motors 32 and 34 are rotated, the shoulder belts 18 and 20 are taken up onto the spools 52 and 56, and medium-level tension is applied to the shoulder belts 18 and 20. In the present exemplary embodiment, each spool 52 or 56 for which the state in which the rotation number is at least the permitted value is still continuing is rotated to apply tension to the corresponding shoulder belt 18 or 20. The application of tension in step 520 is intended to put the upper body of the occupant 42 into contact with the seat back 48. Therefore, the retractor motors 32 and 34 are rotated continuously and the shoulder belts 18 and 20 are taken up continuously. In step 520, the rotation of the retractor motors 32 and 34 may be controlled after the start of take-up of the shoulder belts 18 and 20 so as to steadily increase the tension from the medium level.

In step 522, the current rotation number of the respective spools 52 and 56 of the shoulder belts 18 and 20 are detected.

In step 524, the vehicle ECU 82 makes a determination as to whether the state in which the rotation number of either of the spools 52 and 56 of the shoulder belts 18 and 20 is at least the permitted value greater than the reference value is still continuing. When the result of the determination in step 524 is affirmative, the vehicle ECU 82 returns to step 520 and continues to take up the shoulder belts 18 and 20 onto the spools 52 and 56. When the rotation number of the respective spools 52 and 56 of the shoulder belts 18 and 20 are not above the permitted value, the result of the determination in step 524 is negative and the vehicle ECU 82 proceeds to step 502.

When the result of the determination in step 502 is affirmative, the vehicle ECU 82 makes a determination in step 526 as to whether an application of tension to the shoulder belts 18 and 20 is required. In step 526, the application of tension to the shoulder belts 18 and 20 is required and the result of the determination is affirmative if, for example, a body approaching the vehicle from the front or from the left or right of the vehicle (an oncoming vehicle, a two-wheeled vehicle, a pedestrian or the like) has previously been detected by the millimeter-wave radar 90A, the laser radar 90B, the vehicle-mounted camera 90D and the like, and the vehicle ECU 82 proceeds to step 528. In step 526, if no object approaching the vehicle from the front or from the left or right of the vehicle has been detected by the millimeter-wave radar 90A, the laser radar 90B and the like, the application of tension to the shoulder belts 18 and 20 is not required and the result of the determination is negative, and the vehicle ECU 82 proceeds to step 504.

In step 528, the vehicle ECU 82 makes a determination as to whether the shoulder belts 18 and 20 should be taken up with large tensions. In step 528, the shoulder belts 18 and 20 need to be taken up with large tensions and the result of the determination is affirmative if, for example, there is a risk of collision with an object approaching the vehicle even if the vehicle ECU 82 activates the automatic brake of the vehicle according to detection results from the millimeter-wave radar 90A, the laser radar 90B and the vehicle-mounted camera 90D. Then, in step 530, the occupant 42 is restrained at the vehicle seat 12 by the respective spools 52 and 56 taking up the shoulder belts 18 and 20 with large tensions. When the spools 52 and 56 are each being taken up with strong force, the effective voltage value of the voltage generated by each driving circuit 86 with the PWM described above is raised and the retractor motors 32 and 34 are rotated at high speeds.

In step 530, each of the shoulder belts 18 and 20 is strongly taken up. However, depending on the mode of approach of the object toward the vehicle, either the left or right shoulder belt 18 or 20 may be taken up strongly. For example, when there is a risk of an object colliding from the vehicle right side, the left shoulder belt 20 is strongly taken up and the occupant 42 is inhibited from being thrown out toward the vehicle right side by the collision from the vehicle right side. When there is a risk of an object colliding from the vehicle left side, the right shoulder belt 18 is strongly taken up and the occupant 42 is inhibited from being thrown out toward the vehicle left side by the collision from the vehicle left side. When there is a risk of an object colliding from the vehicle front, the left and right shoulder belts 18 and 20 are both taken up strongly and the occupant 42 is restrained at the vehicle seat 12.

After the occupant 42 has been restrained by the shoulder belts 18 and 20 in step 530, the process is returned.

When take-up of the shoulder belts 18 and 20 with large tensions is not required and the result of the determination in step 528 is negative, the vehicle ECU 82 proceeds to step 532 and gives a warning to the occupant 42 by taking up the shoulder belts 18 and 20. To be specific, when an object such as a pedestrian or the like is at the vehicle right side, the right shoulder belt 18 is taken up with a light or medium-level tension, warning the occupant 42 of the presence of a pedestrian or the like at the vehicle right side. When an object such as a pedestrian or the like is at the vehicle left side, the left shoulder belt 20 is taken up with a light or medium-level tension, warning the occupant 42 of the presence of a pedestrian or the like at the vehicle left side. When an object such as a pedestrian or the like is at the vehicle front, the left and right shoulder belts 18 and 20 are taken up with light or medium-level tensions, warning of the presence of a pedestrian or the like to the front of the vehicle.

After a warning has been given to the occupant 42 by the shoulder belts 18 and 20 in step 532, the process is returned.

As described above, according to the four-point seatbelt device for a vehicle 10 relating to the present exemplary embodiment, pull-out amounts of the shoulder belts 18 and 20 in a state in which the occupant 42 is in an appropriate sitting posture are used as reference values. When current pull-out amounts of the shoulder belts 18 and 20 depart from the reference values, it is determined that the sitting posture of the occupant 42 has been disturbed, the shoulder belts 18 and 20 are taken up to give a warning about sitting posture to the occupant 42, and the pull-out amounts of the shoulder belts 18 and 20 are optimized.

Furthermore, according to the four-point seatbelt device for a vehicle 10 relating to the present exemplary embodiment, when an object such as an oncoming vehicle or the like is present to the front, left or right of the vehicle, the shoulder belts 18 and 20 are taken up to give a warning, and if there is a risk of a vehicle collision, the shoulder belts 18 and 20 are strongly taken up to improve the sitting posture of the occupant and restrain the occupant at the vehicle seat 12, which may improve safety of the occupant 42.

### Second Exemplary Embodiment

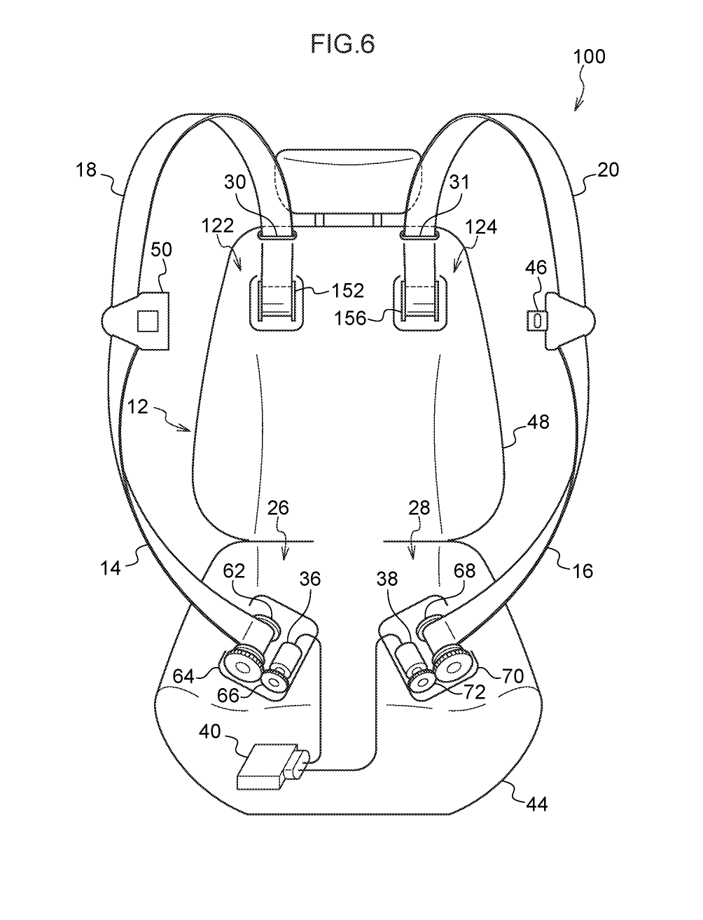

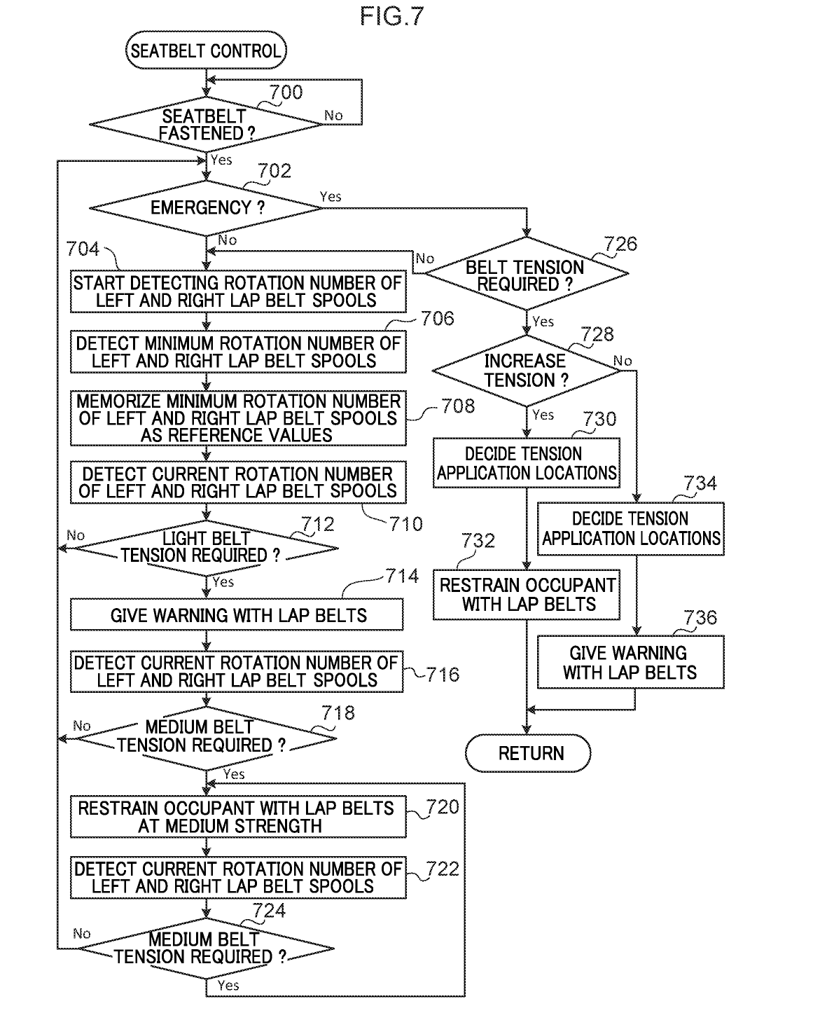

Now, a four-point seatbelt device for a vehicle 100 according to the present exemplary embodiment is described using FIG. 6 and FIG. 7. As shown in FIG. 6, the four-point seatbelt device for a vehicle 100 according to the present exemplary embodiment differs from the four-point seatbelt device for a vehicle 10 according to the first exemplary embodiment in that retractor motors 36 and 38 are provided at spools 62 and 68 of retractors 26 and 28 and take up the lap belts 14 and 16, and in that no retractor motors are provided for taking up the shoulder belts 18 and 20 onto spools 152 and 156 of retractors 122 and 124. Other structures are similar to the four-point seatbelt device for a vehicle 10 according to the first exemplary embodiment. Accordingly, the same reference symbols as in the first exemplary embodiment are applied to these other structures and detailed descriptions thereof are not given.

As shown in FIG. 6, the retractors 26 and 28 are disposed apart in the vehicle width direction in a lower side rear portion of the seat cushion 44 of the vehicle seat 12. The retractor 26 is disposed at the vehicle right side in correspondence with the take-up side end portion of the right lap belt 14 at the vehicle right side, and the retractor 28 is disposed at the vehicle left side in correspondence with the take-up side end portion of the left lap belt 16 at the vehicle left side.

The spool 62 and the retractor motor 36 are disposed inside the retractor 26. The spool 62 is capable of taking up the right lap belt 14 at the vehicle right side. The retractor motor 36 is capable of driving the spool 62 at least in the take-up direction of the right lap belt 14. A gear 64 is attached to a rotary axle of the spool 62, and a gear 66 is attached to a rotary axle of the retractor motor 36. The gears 64 and 66 mesh with one another directly or indirectly. Thus, driving force of the retractor motor 36 is transmitted to the spool 62. In the present exemplary embodiment, the retractor motor 36 is structured to be capable of driving the spool 62 both in the take-up direction of the right lap belt 14 and in the pull-out direction of the right lap belt 14.

The spool 68 and the retractor motor 38 are disposed in the retractor 28. The spool 68 is capable of taking up the left lap belt 16 at the vehicle left side. The retractor motor 38 is capable of driving the spool 68 at least in the take-up direction of the left lap belt 16. A gear 70 is attached to a rotary axle of the spool 68, and a gear 72 is attached to a rotary axle of the retractor motor 38. The gears 70 and 72 mesh with one another directly or indirectly. Thus, driving force of the retractor motor 38 is transmitted to the spool 68. In the present exemplary embodiment, the retractor motor 38 is structured to be capable of driving the spool 68 both in the take-up direction of the left lap belt 16 and in the pull-out direction of the left lap belt 16.

A retractor ECU 140 is connected to the retractor motors 36 and 38. The control circuit 84 and driving circuit 86 are structured integrally with the retractor ECU 140. The retractor motors 36 and 38 are rotated by voltages applied from the retractor ECU 140. The control circuit 84 and driving circuit 86 are respectively dedicatedly provided for each of the retractor motors 36 and 38. The respective control circuits 84 and driving circuits 86 have substantially the same structures. The structure of each control circuit 84 and driving circuit 86 is the same as in the first exemplary embodiment shown in FIG. 3. Therefore, detailed descriptions are not given here.

As shown in FIG. 6, the retractors 122 and 124 are disposed apart in the vehicle width direction in an upper portion of the interior of the seat back 48 of the vehicle seat 12. The retractor 122 is disposed at the vehicle right side in correspondence with the take-up side end portion of the right shoulder belt 18 at the vehicle right side, and the retractor 124 is disposed at the vehicle left side in correspondence with the take-up side end portion of the left shoulder belt 20 at the vehicle left side. The retractors 122 and 124 do not include respective retractor motors that take up the shoulder belts 18 and 20 but do include return springs (not shown in the drawings) that rotate the spools 152 and 156 so as to remove slackness in the shoulder belts 18 and 20 that have been pulled out.

Now, operation of the present exemplary embodiment are described. FIG. 4 is a flowchart showing an example of processing by the vehicle ECU 82 of the four-point seatbelt device for a vehicle 100 according to the present exemplary embodiment. The process from step 700 to step 728 is the same as steps 500 to 528 in the first exemplary embodiment, except that this processing is concerned with the lap belts 14 and 16, minimum rotation number of the respective spools 62 and 68 of the lap belts 14 and 16 are used as the reference values, it is determined that the sitting posture of the waist area of the occupant 42 is disturbed in the left-and-right direction when a current rotation number of the spool 62 or 68 is greater than the reference value, and a permitted value in step 712 is different from the permitted value in step 512 of the first exemplary embodiment. Therefore, detailed descriptions are not given here.

The permitted values and predetermined duration in step 712 vary depending on specifications of the four-point seatbelt device for a vehicle 100 and suchlike, and are specifically determined through testing using real equipment and the like. In general, when the sitting posture of the occupant 42 is disturbed, pull-out amounts of the lap belts 14 and 16 do not change greatly compared to pull-out amounts of the shoulder belts 18 and 20. Therefore, differences between the reference values and permitted values in the present exemplary embodiment are smaller than differences between the reference values and permitted values in the first exemplary embodiment.

In step 730, depending on the mode of approach of an object toward the vehicle, the vehicle ECU 82 decides on strong take-up of either the left or right lap belt 14 or 16. For example, when there is a risk of an object colliding from the vehicle right side, the left lap belt 16 is strongly taken up and the occupant 42 is inhibited from being thrown out toward the vehicle right side by the collision from the vehicle right side. When there is a risk of an object colliding from the vehicle left side, the right lap belt 14 is strongly taken up and the occupant 42 is inhibited from being thrown out toward the vehicle left side by the collision from the vehicle left side. When there is a risk of an object colliding from the vehicle front, the left and right lap belts 14 and 16 are both taken up strongly and the occupant 42 is restrained at the vehicle seat 12.

When there is a risk of an object colliding from the vehicle right side, the action of an excessive load on the right side of the abdomen area and the right side of the waist area of the occupant 42 may be suppressed by the left lap belt 16 being strongly taken up and the right lap belt 14 being pulled out. When there is a risk of an object colliding from the vehicle left side, the action of an excessive load on the left side of the abdomen area and the left side of the waist area of the occupant 42 may be suppressed by the right lap belt 14 being strongly taken up and the left lap belt 16 being pulled out.

In step 732, when the spools 62 and 68 are respectively being taken up with large forces, the effective voltage value of the voltage generated by each driving circuit 86 with the PWM described above is raised and the retractor motors 36 and 38 are rotated at high speeds.

After the occupant 42 has been restrained by the lap belts 14 and 16 in step 732, the process is returned.

When take-up of the lap belts 14 and 16 with large tensions is not required and the result of the determination in step 728 is negative, then in step 734, take-up of either the left or right lap belt 14 or 16 is decided in accordance with a position of the object. To be specific, when an object such as a pedestrian or the like is at the vehicle right side, the right lap belt 14 is taken up, warning the occupant 42 of the presence of a pedestrian or the like at the vehicle right side. When an object such as a pedestrian or the like is at the vehicle left side, the left lap belt 16 is taken up, warning the occupant 42 of the presence of a pedestrian or the like at the vehicle left side. When an object such as a pedestrian or the like is at the vehicle front, the left and right lap belts 14 and 16 are taken up, warning of the presence of a pedestrian or the like to the front of the vehicle.

In step 736, the lap belts 14 and 16 decided on in step 734 are taken up with light to medium-level tensions, and then the process is returned.

As described above, according to the four-point seatbelt device for a vehicle 100 relating to the present exemplary embodiment, pull-out amounts of the lap belts 14 and 16 in a state in which the occupant 42 is in an appropriate sitting posture are used as reference values. When current pull-out amounts of the lap belts 14 and 16 depart from the reference values, it is determined that the sitting posture of the occupant 42 has been disturbed, the lap belts 14 and 16 are taken up to give a warning about sitting posture to the occupant 42, and the pull-out amounts of the lap belts 14 and 16 are optimized.

Furthermore, according to the four-point seatbelt device for a vehicle 100 relating to the present exemplary embodiment, when an object such as an oncoming vehicle or the like is present to the front, left or right of the vehicle, the lap belts 14 and 16 are taken up to give a warning, and if there is a risk of a vehicle collision, the lap belts 14 and 16 are strongly taken up to improve the sitting posture of the occupant and restrain the occupant at the vehicle seat 12, which may improve safety of the occupant 42.

Further still, according to the four-point seatbelt device for a vehicle 100 relating to the present exemplary embodiment, because the specific lap belts 14 and 16 are taken up or pulled out (slackened) in accordance with a mode of collision of an object with the vehicle, protection of the occupant 42 may be conducted effectively.

### Third Exemplary Embodiment

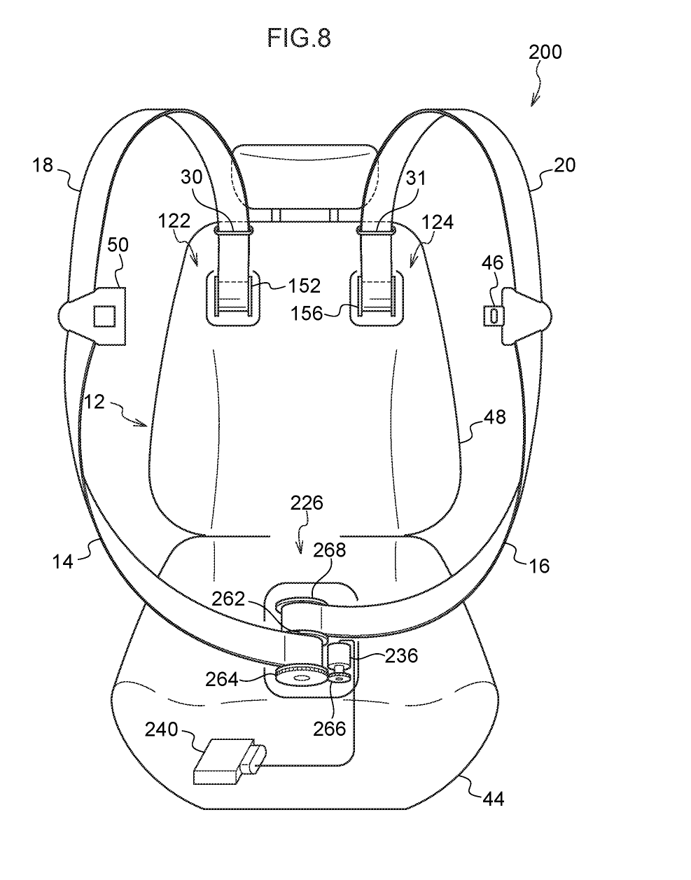

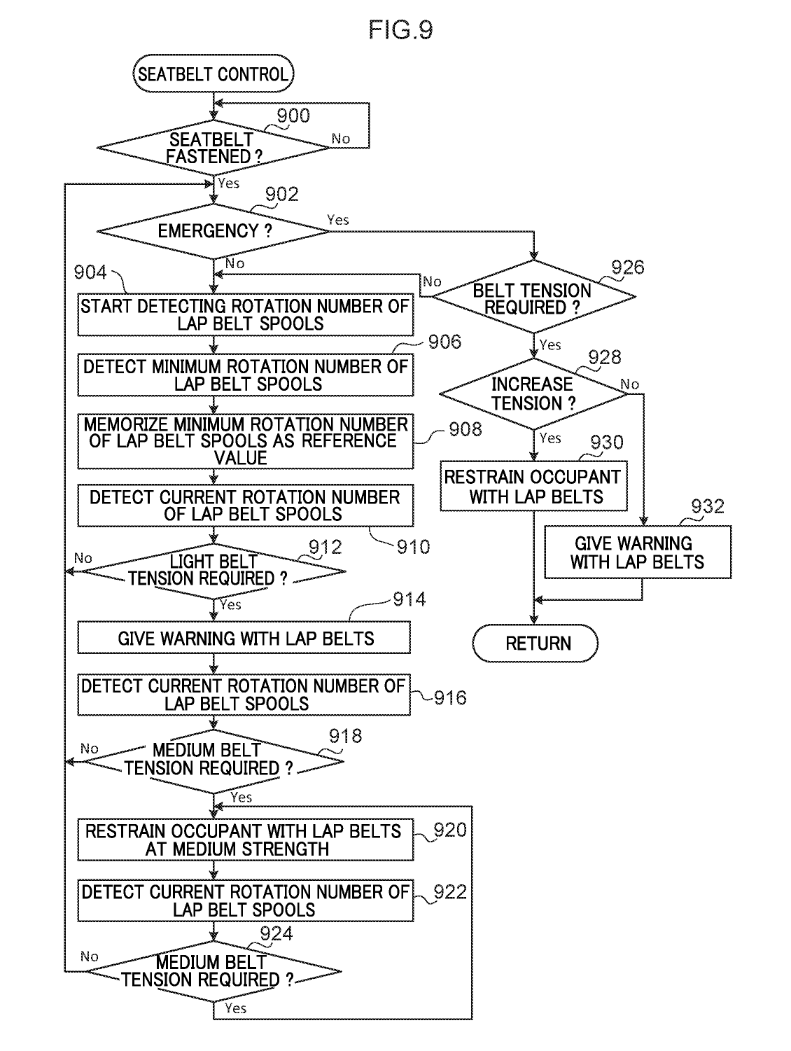

Now, a four-point seatbelt device for a vehicle 200 according to the present exemplary embodiment is described using FIG. 8 and FIG. 9. As shown in FIG. 8, the four-point seatbelt device for a vehicle 200 according to the present exemplary embodiment differs from the four-point seatbelt device for a vehicle 100 according to the second exemplary embodiment in that spools 262 and 268 of a retractor 226 are driven by a single retractor motor 236. Other structures are similar to the four-point seatbelt device for a vehicle 100 according to the second exemplary embodiment and the four-point seatbelt device for a vehicle 10 according to the first exemplary embodiment. Accordingly, the same reference symbols as in the first exemplary embodiment and the second exemplary embodiment are applied to these other structures and detailed descriptions thereof are not given.

As shown in FIG. 8, the retractor 226 is disposed in a lower side rear portion of the seat cushion 44 of the vehicle seat 12. The spool 262, the spool 268 and the retractor motor 236 are disposed in the retractor 226. The spool 262 is capable of taking up the right lap belt 14 at the vehicle right side, and the spool 268 is capable of taking up the left lap belt 16 at the vehicle left side. The retractor motor 236 is capable of driving the spools 262 and 268 at least in the take-up directions of the lap belts 14 and 16. A rotary axle of the spool 262 and a rotary axle of the spool 268 are the same axle. A gear 264 is attached to this rotary axle, and a gear 266 is attached to a rotary axle of the retractor motor 236. The gears 264 and 266 mesh with one another directly or indirectly. Thus, driving force of the retractor motor 236 is transmitted to the spools 262 and 268. In the present exemplary embodiment, the retractor motor 236 is structured to be capable of driving the spools 262 and 268 both in the take-up directions of the lap belts 14 and 16 and in the pull-out directions of the lap belts 14 and 16.

A retractor ECU 240 is connected to the retractor motor 236. The control circuit 84 and driving circuit 86 are structured integrally with the retractor ECU 240. The retractor motor 236 is rotated by voltages applied from the retractor ECU 240. The structures of the control circuit 84 and driving circuit 86 are the same as in the first exemplary embodiment shown in FIG. 3. Therefore, detailed descriptions are not given here.

Now, operation and effects of the present exemplary embodiment are described. FIG. 9 is a flowchart showing an example of processing by the vehicle ECU 82 of the four-point seatbelt device for a vehicle 200 according to the present exemplary embodiment. The process from step 900 to step 928 is the same as steps 500 to 528 in the first exemplary embodiment, except that this processing is concerned with the lap belts 14 and 16, a minimum value rotation number of the spools 262 and 268 whose rotary axles are the same axle is used as the reference value, it is determined that the sitting posture of the waist area of the occupant 42 is disturbed in the front-and-rear direction when a current rotation number of the spools 262 and 268 is greater than the reference value, and a permitted value in step 912 is different from the permitted value in step 512 of the first exemplary embodiment. Therefore, detailed descriptions are not given here.

The permitted value and predetermined duration in step 912 vary depending on specifications of the four-point seatbelt device for a vehicle 200 and suchlike, and are specifically determined through testing using real equipment and the like. In general, when the sitting posture of the occupant 42 is disturbed, pull-out amounts of the lap belts 14 and 16 do not change greatly compared to pull-out amounts of the shoulder belts 18 and 20. Therefore, differences between the reference values and permitted values in the present exemplary embodiment are smaller than differences between the reference values and permitted values in the first exemplary embodiment.

In step 930, the occupant 42 is restrained at the vehicle seat 12 by the lap belts 14 and 16, by the spools 262 and 268 taking up the lap belts 14 and 16 with large tensions. When the spools 262 and 268 are each being taken up with strong force, the effective voltage value of the voltage generated by the driving circuit 86 with the PWM described above is raised and the spools 262 and 268 are rotated at high speed.

After the occupant 42 has been restrained by the lap belts 14 and 16 in step 930, the process is returned.

When take-up of the lap belts 14 and 16 with large tensions is not required and the result of the determination in step 928 is negative, in step 932 the lap belts 14 and 16 are taken up with light to medium-level tensions, giving a warning to the occupant 42. Then, after the lap belts 14 and 16 are taken up with light to medium-level tensions in step 932, the process is returned.

As described above, according to the four-point seatbelt device for a vehicle 200 relating to the present exemplary embodiment, a pull-out amount of the lap belts 14 and 16 in a state in which the occupant 42 is in an appropriate sitting posture is used as a reference value. When a current pull-out amount of the lap belts 14 and 16 departs from the reference value, it is determined that the sitting posture of the occupant 42 has been disturbed, the lap belts 14 and 16 are taken up to give a warning about sitting posture to the occupant 42, and the pull-out amounts of the lap belts 14 and 16 are optimized.

Furthermore, according to the four-point seatbelt device for a vehicle 200 relating to the present exemplary embodiment, when an object such as an oncoming vehicle or the like is present to the front, left or right of the vehicle, the lap belts 14 and 16 are taken up to give a warning, and if there is a risk of a vehicle collision, the lap belts 14 and 16 are strongly taken up to restrain the occupant at the seat cushion 44 of the vehicle seat 12, which may suppress a “submarining” effect with a simple structure and improve safety of the occupant 42.

### Fourth Exemplary Embodiment

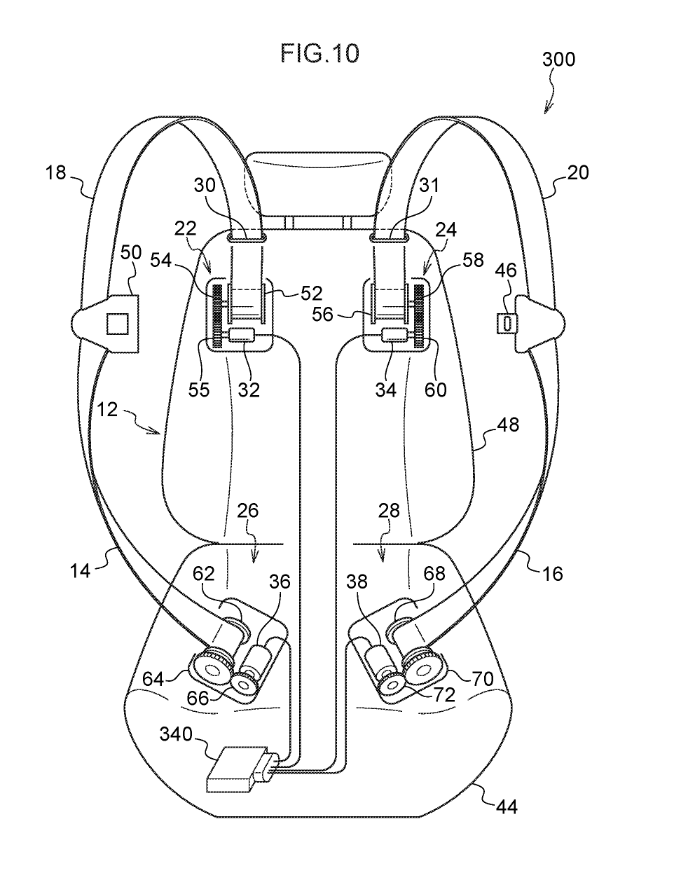

Now, a four-point seatbelt device for a vehicle 300 according to the present exemplary embodiment is described using FIG. 10. As shown in FIG. 10, the four-point seatbelt device for a vehicle 300 according to the present exemplary embodiment is similar to the four-point seatbelt device for a vehicle 10 according to the first exemplary embodiment in that the shoulder belts 18 and 20 are taken up by the retractor motors 32 and 34, and is similar to the four-point seatbelt device for a vehicle 100 according to the second exemplary embodiment in that the lap belts 14 and 16 are taken up by the retractor motors 36 and 38. Other structures are similar to the four-point seatbelt device for a vehicle 10 according to the first exemplary embodiment and the four-point seatbelt device for a vehicle 100 according to the second exemplary embodiment. Accordingly, detailed descriptions thereof are not given.

A retractor ECU 340 is connected to the retractor motors 32, 34, 36 and 38. The control circuits 84 and driving circuits 86 are structured integrally with the retractor ECU 340. The retractor motors 32, 34, 36 and 38 are rotated by voltages applied from the retractor ECU 340. The control circuit 84 and driving circuit 86 are respectively dedicatedly provided for each of the retractor motors 32, 34, 36 and 38. The respective control circuits 84 and driving circuits 86 have substantially the same structures. The structure of each control circuit 84 and driving circuit 86 is the same as in the first exemplary embodiment shown in FIG. 3. Therefore, detailed descriptions are not given here.

By the shoulder belts 18 and 20 being taken up in accordance with the first exemplary embodiment, and by the lap belts 14 and 16 being taken up in accordance with the second exemplary embodiment, respective warnings are given about the sitting posture of the occupant and pull-out amounts of the lap belts 14 and 16 are optimized. In the present exemplary embodiment, when the rotation number of any of the spools 52 and 56 of the shoulder belts 18 and 20 and the spools 62 and 68 of the lap belts 14 and 16 is greater than the permitted value, the shoulder belt 18 or 20 or lap belt 14 or 16 that is taken up by the spool 52, 56, 62 or 68 at which the rotation number is greater than the permitted value may be taken up, giving a warning to the occupant 42. For example, when the upper body of the occupant 42 lifts up from the seat back 48, at least one of the shoulder belts 18 and 20 is taken up intermittently to give a warning to the occupant 42, and when the waist area of the occupant 42 shifts from the seat cushion 44, at least one of the lap belts 14 and 16 is taken up intermittently to give a warning to the occupant 42.

As described above, depending on a positional relationship between the vehicle and an object with which there is a risk of collision, the first exemplary embodiment takes up at least one of the shoulder belts 18 and 20 and the second exemplary embodiment takes up at least one of the lap belts 14 and 16. In the present exemplary embodiment, depending on a positional relationship between the vehicle and an object with which there is a risk of collision, at least one of the shoulder belts 18 and 20 and at least one of the lap belts 14 and 16 are taken up. Therefore, a higher level of protection of the occupant may be realized.

For example, when there is a risk of an object colliding from the vehicle right side, the left shoulder belt 20 is strongly taken up, the left lap belt 16 is strongly taken up, and the occupant 42 is inhibited from being thrown out toward the vehicle right side by the collision from the vehicle right side.

When there is a risk of an object colliding from the vehicle left side, the right shoulder belt 18 is strongly taken up, the right lap belt 14 is strongly taken up, and the occupant 42 is inhibited from being thrown out toward the vehicle left side by the collision from the vehicle left side.

When there is a risk of an object colliding from the vehicle front, the left and right shoulder belts 18 and 20 are both taken up strongly, the left and right lap belts 14 and 16 are both taken up strongly, and the occupant 42 is restrained at the vehicle seat 12.

Further, when there is a risk of an object colliding from the vehicle right side, the action of an excessive load on the right side of the abdomen area and the right side of the waist area of the occupant 42 may be suppressed by the left shoulder belt 20 and the left lap belt 16 being strongly taken up and the right lap belt 14 being pulled out. When there is a risk of an object colliding from the vehicle left side, the action of an excessive load on the left side of the abdomen area and the left side of the waist area of the occupant 42 may be suppressed by the right shoulder belt 18 and the right lap belt 14 being strongly taken up and the left lap belt 16 being pulled out.

As described above, according to the four-point seatbelt device for a vehicle 300 relating to the present exemplary embodiment, pull-out amounts of the shoulder belts 18 and 20 and the lap belts 14 and 16 in a state in which the occupant 42 is in an appropriate sitting posture are used as reference values. When a current pull-out amount of the shoulder belts 18 and 20 or the lap belts 14 and 16 departs from the reference value, it is determined that the sitting posture of the occupant 42 has been disturbed, the shoulder belts 18 and 20 or the lap belts 14 and 16 are taken up to give a warning about sitting posture to the occupant 42, and the pull-out amounts of the shoulder belts 18 and 20 or the lap belts 14 and 16 are optimized.

Furthermore, according to the four-point seatbelt device for a vehicle 300 relating to the present exemplary embodiment, when there is a risk of a vehicle collision, the shoulder belts 18 and 20 and the lap belts 14 and 16 are strongly taken up to improve the sitting posture of the occupant and restrain the occupant at the vehicle seat 12, which may improve safety of the occupant 42.

Further still, according to the four-point seatbelt device for a vehicle 300 relating to the present exemplary embodiment, because the specific shoulder belts 18 and 20 are taken up and the specific lap belts 14 and 16 are taken up or pulled out (slackened) in accordance with a mode of collision of an object with the vehicle, protection of the occupant 42 may be conducted effectively.

### Fifth Exemplary Embodiment

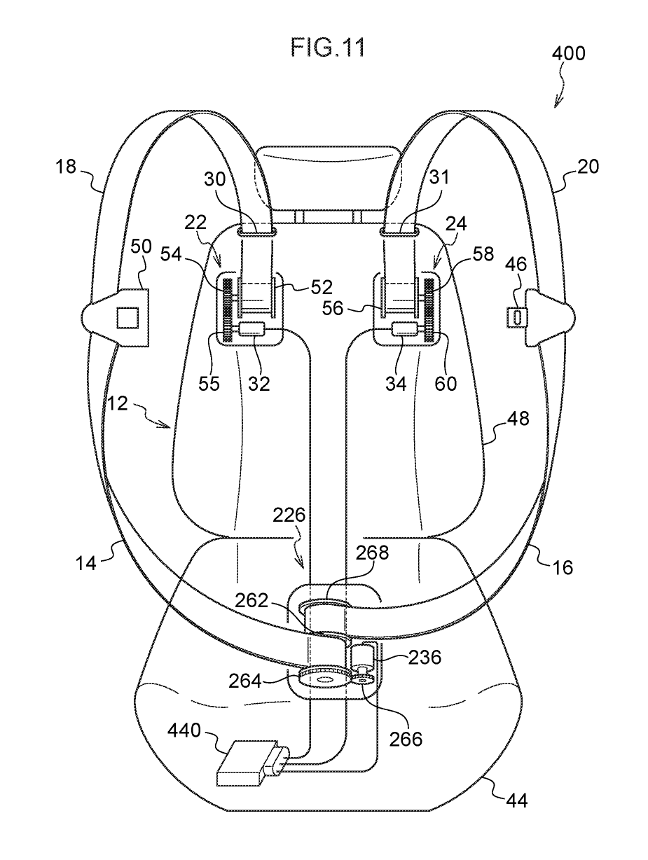

Now, a four-point seatbelt device for a vehicle 400 according to the present exemplary embodiment is described using FIG. 11. As shown in FIG. 11, the four-point seatbelt device for a vehicle 400 according to the present exemplary embodiment is similar to the four-point seatbelt device for a vehicle 10 according to the first exemplary embodiment in that the shoulder belts 18 and 20 are taken up by the retractor motors 32 and 36, and is similar to the four-point seatbelt device for a vehicle 200 according to the third exemplary embodiment in that the lap belts 14 and 16 are taken up by the single retractor motor 236. Other structures are similar to the four-point seatbelt device for a vehicle 10 according to the first exemplary embodiment and the four-point seatbelt device for a vehicle 200 according to the third exemplary embodiment. Accordingly, detailed descriptions thereof are not given.

A retractor ECU 440 is connected to the retractor motors 32, 34 and 236. The control circuit 84 and driving circuit 86 are structured integrally with the retractor ECU 440. The retractor motors 32, 34 and 236 are rotated by voltages applied from the retractor ECU 440. The control circuit 84 and driving circuit 86 are respectively dedicatedly provided for each of the retractor motors 32, 34 and 236. The respective control circuits 84 and driving circuits 86 have substantially the same structures. The structure of each control circuit 84 and driving circuit 86 is the same as in the first exemplary embodiment shown in FIG. 3. Therefore, detailed descriptions are not given here.

By the shoulder belts 18 and 20 being taken up in accordance with the first exemplary embodiment, and by the lap belts 14 and 16 being taken up in accordance with the third exemplary embodiment, respective warnings are given about the sitting posture of the occupant and pull-out amounts of the lap belts 14 and 16 are optimized. In the present exemplary embodiment, when the rotation number of any of the spools 52 and 56 of the shoulder belts 18 and 20 and the spools 262 and 268 of the lap belts 14 and 16 is greater than the permitted value, the shoulder belt 18 or 20 or lap belts 14 and 16 that is/are taken up by the spool 52 or 56 or spools 262 and 268 at which the rotation number is greater than the permitted value may be taken up, giving a warning to the occupant 42. For example, when the upper body of the occupant 42 lifts up from the seat back 48, at least one of the shoulder belts 18 and 20 is taken up intermittently to give a warning to the occupant 42, and when the waist area of the occupant 42 shifts from the seat cushion 44, the lap belts 14 and 16 are taken up intermittently to give a warning to the occupant 42.

As described above, depending on a positional relationship between the vehicle and an object with which there is a risk of collision, the first exemplary embodiment takes up at least one of the shoulder belts 18 and 20. In the present exemplary embodiment, depending on a positional relationship between the vehicle and an object with which there is a risk of collision, at least one of the shoulder belts 18 and 20 and both of the lap belts 14 and 16 are taken up. Therefore, more assured protection of the occupant may be realized.

For example, when there is a risk of an object colliding from the vehicle right side, the left shoulder belt 20 is strongly taken up, the lap belts 14 and 16 are strongly taken up, and the occupant 42 is inhibited from being thrown out toward the vehicle right side by the collision from the vehicle right side.

When there is a risk of an object colliding from the vehicle left side, the right shoulder belt 18 is strongly taken up, the lap belts 14 and 16 are strongly taken up, and the occupant 42 is inhibited from being thrown out toward the vehicle left side by the collision from the vehicle left side.

When there is a risk of an object colliding from the vehicle front, the left and right shoulder belts 18 and 20 are both taken up strongly, the left and right lap belts 14 and 16 are both taken up strongly, and the occupant 42 is restrained at the vehicle seat 12.

As described above, according to the four-point seatbelt device for a vehicle 400 relating to the present exemplary embodiment, pull-out amounts of the shoulder belts 18 and 20 and the lap belts 14 and 16 in a state in which the occupant 42 is in an appropriate sitting posture are used as reference values. When a current pull-out amount of the shoulder belts 18 and 20 or the lap belts 14 and 16 departs from the reference value, it is determined that the sitting posture of the occupant 42 has been disturbed, the shoulder belts 18 and 20 or the lap belts 14 and 16 are taken up to give a warning about sitting posture to the occupant 42, and the pull-out amounts of the shoulder belts 18 and 20 or the lap belts 14 and 16 are optimized.

Furthermore, according to the four-point seatbelt device for a vehicle 400 relating to the present exemplary embodiment, when there is a risk of a vehicle collision, the shoulder belts 18 and 20 and the lap belts 14 and 16 are strongly taken up to improve the sitting posture of the occupant and restrain the occupant at the vehicle seat 12, which may improve safety of the occupant 42.

The front latch portion corresponds to the tongue plate 46 and the buckle device 50, the pull-out amount detection section corresponds to the rotation detection sensors 90F, the sitting posture detection section corresponds to the vehicle ECU, and the electric motor corresponds to each of the retractor motors 32, 34, 36, 38 and 236.

What is claimed is:

1. A four-point seatbelt device for a vehicle comprising:
a left and right pair of lap belts corresponding with the waist area of an occupant sitting on a vehicle seat;
a left and right pair of shoulder belts connected with the respective lap belts, the left and right pair of shoulder belts corresponding with the chest area of the occupant;
a front latch portion connecting and disconnecting the left lap belt and left shoulder belt with the right lap belt and right shoulder belt at a front face of the occupant;
a retractor disposed at a take-up side end portion of at least one belt of the lap belts and the shoulder belts, the retractor being capable of taking up and pulling out the belt;
a pull-out amount detection section capable of detecting a pull-out amount of the belt from the retractor; and
a sitting posture detection section configured to determine the sitting posture of the occupant on the basis of the pull-out amount detected by the pull-out amount detection section, in a case in which a sitting posture of the occupant changes after the occupant sits on the vehicle seat and the front latch portion is connected.

2. The four-point seatbelt device for a vehicle according to claim 1, wherein:
the retractor is provided at the take-up side end portion of each of the left and right shoulder belts; and
the sitting posture detection section determines the sitting posture of an upper body of the occupant in a left-and-right direction on the basis of a reference value which is a pull-out amount of the shoulder belts when the occupant is sitting properly and a pull-out amount of the shoulder belts detected by the pull-out amount detection section at a time of the determination.

3. The four-point seatbelt device for a vehicle according to claim 1, wherein:
the retractor is provided at the take-up side end portion of each of the left and right lap belts; and
the sitting posture detection section determines the sitting posture of a waist area of the occupant in a left-and-right direction on the basis of a reference value which is a pull-out amount of the lap belts when the occupant is sitting properly and a pull-out amount of the lap belts detected by the pull-out amount detection section a time of the determination.

4. The four-point seatbelt device for a vehicle according to claim 1, wherein:
the retractor is a single retractor that takes up and pulls out both the left and right lap belts together; and
the sitting posture detection section determines the sitting posture of a waist area of the occupant in a front-and-rear direction on the basis of a reference value which is a pull-out amount of the lap belts when the occupant is sitting properly and a pull-out amount of the lap belts detected by the pull-out amount detection section a time of the determination.

5. The four-point seatbelt device for a vehicle according to claim 2, wherein:
the sitting posture detection section sets the reference value to a minimum value of pull-out amounts detected by the pull-out amount detection section, between a time when the occupant sits on the vehicle seat and the front latch portion is connected and the time of the determination.

6. The four-point seatbelt device for a vehicle according to claim 2, wherein:
the retractor comprises an electric motor that takes up the belt; and
in a case in which a pull-out amount detected by the pull-out amount detection section exceeds a permitted value that is greater than the reference value for at least a predetermined duration, the sitting posture detection section controls rotation of the electric motor so as to take up the belt with the retractor.

7. The four-point seatbelt device for a vehicle according to claim 6, wherein:
at the start of take-up of the belt, the sitting posture detection section controls the rotation of the electric motor to moderate tension of the belt and to take up the belt intermittently and,
when a pull-out amount detected by the pull-out amount detection section exceeds the permitted value after the start of take-up of the belt, the sitting posture detection section controls the rotation of the electric motor to make the tension of the belt greater than at the start of take-up and take up the belt.
